(19) United States
(12) Patent Application Publication
(10) Pub. No.: US 2016/0014803 A1
(43) Pub. Date: Jan. 14, 2016

(54) SYSTEMS AND METHODS FOR TRAFFIC INFORMATION SIGNALING IN A WIRELESS COMMUNICATIONS NETWORK

(71) Applicant: QUALCOMM Incorporated, San Diego, CA (US)

(72) Inventors: Simone Merlin, San Diego, CA (US); Gwendolyn Denise Barriac, Encinitas, CA (US); George Cherian, San Diego, CA (US)

(21) Appl. No.: 14/794,525

(22) Filed: Jul. 8, 2015

Related U.S. Application Data
(60) Provisional application No. 62/022,574, filed on Jul. 9, 2014.

(51) Int. Cl. H04W 72/12; H04W 28/02; H04H 20/55

(52) U.S. Cl. CPC H04W 72/1278; H04H 20/55; H04W 28/02; H04W 88/02

(57) ABSTRACT

Methods, devices, and computer program products for traffic information signaling in a wireless communication network are disclosed. In one aspect, a method of communicating within a wireless communication network is disclosed. The method includes receiving, by a transmitting device, a request for buffer information from an access point. The method further includes generating at least one of a buffer size or a transmission time, the buffer size or the transmission time comprising information indicating an amount of data that the transmitting device has buffered for transmission in a multiple-user packet to the access point. The method further includes transmitting the at least one of the buffer size or the transmission time to the access point. In some aspects, the at least one of the buffer size or the transmission time is transmitted within a Very High Throughput (VHT) control field.

### CROSS REFERENCE TO PRIORITY APPLICATION

This application claims priority under 35 U.S.C. §119(e) to U.S. Provisional Patent Application 62/022,574 entitled “SYSTEMS AND METHODS FOR TRAFFIC INFORMATION SIGNALING IN A WIRELESS COMMUNICATIONS NETWORK” filed on Jul. 9, 2014, the disclosure of which is hereby incorporated by reference in its entirety.

### BACKGROUND

1. Field

The present application relates generally to wireless communications, and more specifically to systems, methods, and devices for signaling traffic information. Certain aspects herein relate to traffic signaling which may allow for efficient use of the wireless medium.

2. Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), or personal area network (PAN). Networks can also differ according to the switching/routing technique used to interconnect the various network nodes and devices (e.g. circuit switching vs. packet switching), the type of physical media employed for transmission (e.g. wired vs. wireless), and the set of communication protocols used (e.g. Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

The devices in a wireless network may transmit/receive information between each other. The information may comprise packets, which in some aspects may be referred to as data units. In some aspects, multiple devices may transmit to a single device simultaneously. However, in order to synchronize such transmissions, it may be beneficial for an access point to be aware of certain traffic information from associated wireless devices.

### SUMMARY

The systems, methods, devices, and computer program products discussed herein each have several aspects, no single one of which is solely responsible for its desirable attributes. Without limiting the scope of this invention as expressed by the claims which follow, some features are discussed briefly below. After considering this discussion, and particularly after reading the section entitled “Detailed Description,” it will be understood how advantageous features of this invention allow for efficient use of the wireless communication medium.

In one aspect, a method of communicating within a wireless communication network is disclosed. The method includes receiving, by a transmitting device, a request for buffer information from an access point. The method further includes generating at least one of a buffer size or a transmission time, the buffer size or the transmission time comprising information indicating an amount of data that the transmitting device has buffered for transmission in a multiple-user packet to an access point. The method further includes transmitting the at least one of the buffer size or the transmission time to the access point.

In another aspect, a transmitting device for communicating within a wireless communication network is disclosed. The transmitting device includes a receiver configured to receive a request for buffer information from an access point. The transmitting device further includes a processor configured to generate at least one of a buffer size or a transmission time, the buffer size or the transmission time comprising information indicating an amount of data that the transmitting device has buffered for transmission in a multiple-user packet to an access point. The transmitting device further includes a transmitter configured to transmit the at least one of the buffer size or the transmission time to the access point.

Some aspects of the present disclosure relate to a transmitting device for communicating within a wireless communication network. The transmitting device includes means for receiving a request for buffer information from an access point. The transmitting device further includes means for generating at least one of a buffer size or a transmission time, the buffer size or the transmission time comprising information indicating an amount of data that the transmitting device has buffered for transmission in a multiple-user packet to an access point. The transmitting device further includes means for transmitting the at least one of the buffer size or the transmission time to the access point.

Another aspect of the present disclosure relates to a non-transitory computer readable medium comprising instructions that, when executed, perform a method of communicating within a wireless communication network. The method includes receiving a request for buffer information from an access point. The method further includes generating at least one of a buffer size or a transmission time, the buffer size or the transmission time comprising information indicating an amount of data that a transmitting device has buffered for transmission in a multiple-user packet to an access point. The method further includes transmitting the at least one of the buffer size or the transmission time to the access point.

Details of one or more embodiments of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 illustrates an example of a wireless communication system in which aspects of the present disclosure may be employed.

FIG. 2 shows a functional block diagram of an exemplary wireless device that may be employed within the wireless communication system of FIG. 1.

FIG. 3 is an exemplary format for buffer information transmitted from a wireless device to an access point in order to allow multiple-user uplink data transmissions, in accordance with an exemplary embodiment.

FIG. 4 is another exemplary format for buffer information transmitted from a wireless device to an access point in order to allow multiple-user uplink data transmissions, in accordance with an exemplary embodiment.

FIG. 5 is yet another exemplary format for buffer information transmitted from a wireless device to an access point in order to allow multiple-user uplink data transmissions, in accordance with an exemplary embodiment.

FIG. 6A is an illustration of an exemplary information element that could be used to convey buffer information, in accordance with an exemplary embodiment.

FIG. 6B is an illustration of a management frame format, in accordance with an exemplary embodiment.

FIG. 7 illustrates buffer information which is transmitted as a subfield of a field, in accordance with an exemplary embodiment.

FIG. 8A is an illustration of an High Throughput (HT) Control Field which may be transmitted in accordance with aspects of the present disclosure.

FIG. 8B is an illustration of the components of the HT Control Middle subfield of a VHT (Very High Throughput) variant, in accordance with an exemplary embodiment.

FIG. 8C is an illustration of the components of the HT Control Middle subfield of an HT variant, in accordance with an exemplary embodiment.

FIG. 9A is an illustration of a format for an IEEE 802.11ax packet which may be transmitted in accordance with aspects of the present disclosure.

FIG. 9B is an illustration of a Traffic Specification (TSPEC), in accordance with an exemplary embodiment.

FIG. 10 is an example of a buffer information poll and a response to a single station, in accordance with an exemplary embodiment.

FIG. 11 is an example of a buffer information poll and a response to a multiple stations, in accordance with an exemplary embodiment.

FIG. 12 is an illustration of a possible poll control frame 1200 format, in accordance with an exemplary embodiment.

FIG. 13 illustrates a possible format for a poll frame 1300 that is a management frame, in accordance with an exemplary embodiment.

FIG. 14 is an example of a series of communications between an access point and eight stations according to some aspects of the present disclosure.

FIG. 15 is a method of transmitting buffer information from a station to an access point, in accordance with an exemplary embodiment.

FIG. 16 is a method of receiving buffer information from a station by an access point, in accordance with an exemplary embodiment.

### DETAILED DESCRIPTION

Various aspects of the novel systems, apparatuses, and methods are described more fully hereinafter with reference to the accompanying drawings. The teachings disclosed may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Wireless network technologies may include various types of wireless local area networks (WLANs). A WLAN may be used to interconnect nearby devices together, employing widely used networking protocols. The various aspects described herein may apply to any communication standard, such as Wi-Fi or, more generally, any member of the IEEE 802.11 family of wireless protocols.

In some aspects, wireless signals may be transmitted according to an 802.11 protocol using orthogonal frequency-division multiplexing (OFDM), orthogonal frequency-division multiple access (OFDMA), direct—sequence spread spectrum (DSSS) communications, a combination of OFDM and DSSS communications, or other schemes.

In some implementations, a WLAN includes various devices which are the components that access the wireless network. For example, there may be two types of devices: access points (“APs”) and clients (also referred to as stations, commonly known as “STAs”). In general, an AP serves as a hub or base station for the WLAN and an STA serves as a user of the WLAN. For example, an STA may be a laptop computer, a personal digital assistant (PDA), a mobile phone, etc. In an example, an STA connects to an AP via a Wi-Fi (e.g., IEEE 802.11 protocol) compliant wireless link to obtain general connectivity to the Internet or to other wide area networks. In some implementations an STA may also be used as an AP.

An access point (“AP”) may also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

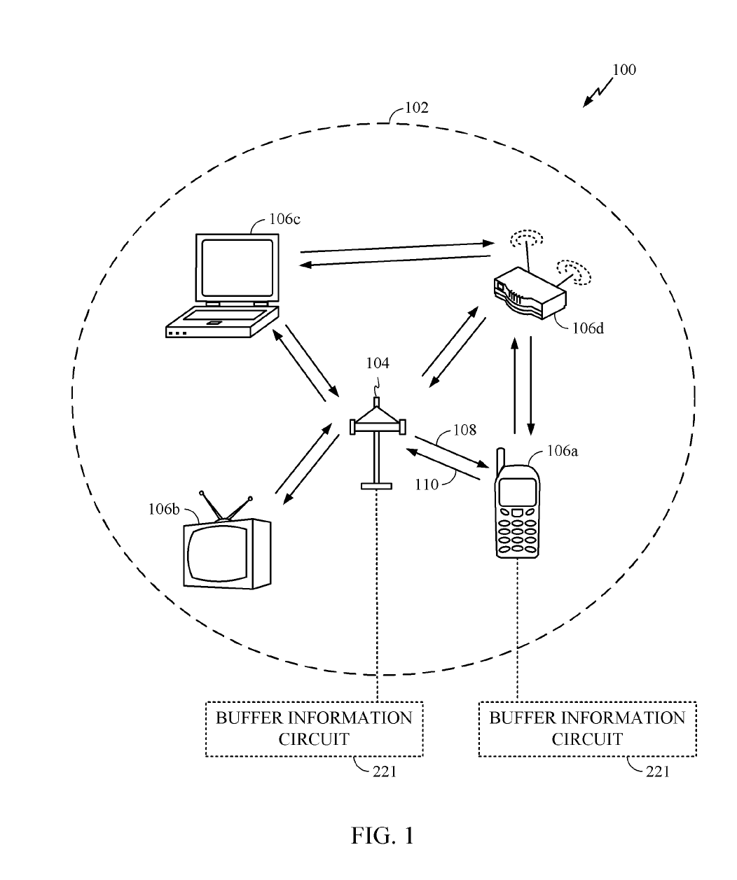

FIG. 1 illustrates an example of a wireless communication system 100 in which aspects of the present disclosure may be employed. The wireless communication system 100 may operate pursuant to a wireless standard. The wireless communication system 100 may include an AP 104, which communicates with STAs 106a-d (referred to herein collectively as “STAs 106” or individually as STA 106).

A variety of processes and methods may be used for transmissions in the wireless communication system 100 between the AP 104 and the STAs 106. For example, signals may be sent and received between the AP 104 and the STAs 106 in accordance with OFDM/OFDMA techniques. If this is the case, the wireless communication system 100 may be referred to as an OFDM/OFDMA system. Alternatively, signals may be sent and received between the AP 104 and the STAs 106 in accordance with CDMA techniques. If this is the case, the wireless communication system 100 may be referred to as a CDMA system.

A communication link that facilitates transmission from the AP 104 to one or more of the STAs 106 may be referred to as a downlink (DL) 108, and a communication link that facilitates transmission from one or more of the STAs 106 to the AP 104 may be referred to as an uplink (UL) message 110. Alternatively, a downlink 108 may be referred to as a forward link or a forward channel, and an uplink message 110 may be referred to as a reverse link or a reverse channel.

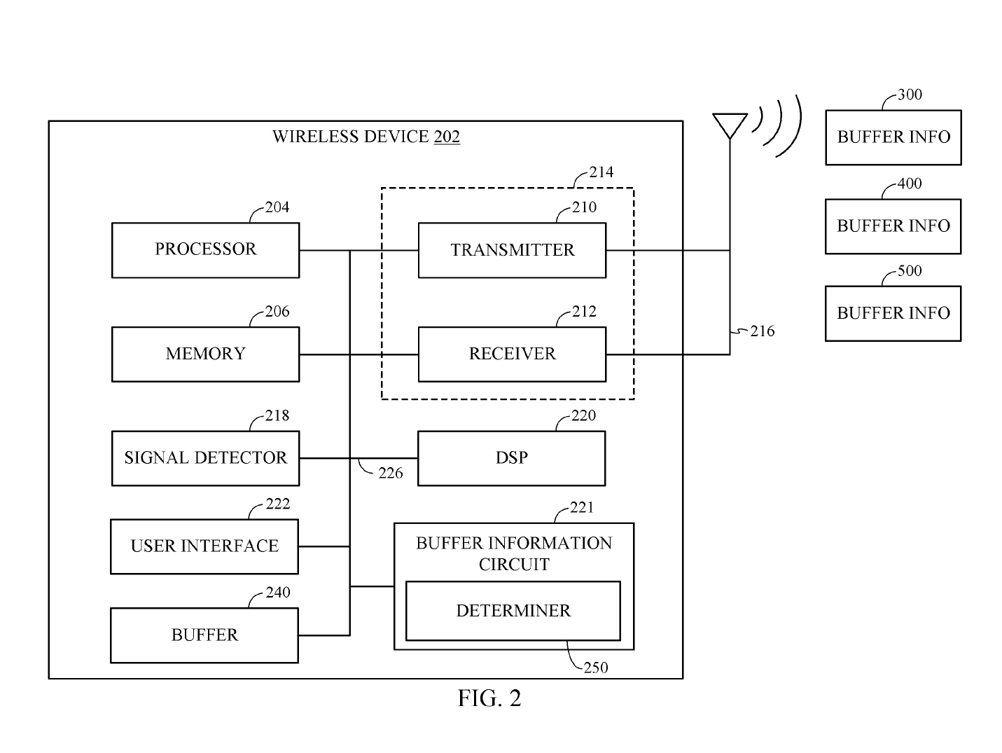

The AP 104 may act as a base station and provide wireless communication coverage in a basic service area (BSA) 102. The AP 104 along with the STAs 106 associated with the AP 104 and that use the AP 104 for communication may be referred to as a basic service set (BSS). It should be noted that the wireless communication system 100 may not have a central AP 104, but rather may function as a peer-to-peer network between the STAs 106. Accordingly, the functions of the AP 104 described herein may alternatively be performed by one or more of the STAs 106. In some aspects, the AP 104 or at least one of the STAs 106 may include a buffer information circuit 221, described in further detail below with respect to FIG. 2. This buffer information circuit 221 may contain instructions which allow the device to determine or transmit information about data which is buffered on that device, which may allow for efficient use of the wireless medium.

FIG. 2 illustrates a functional block diagram of an exemplary wireless device 202 that may be employed within the wireless communication system 100 of FIG. 1. The wireless device 202 is an example of a device that may be configured to implement the various methods described herein. For example, the wireless device 202 may comprise the AP 104 or one of the STAs 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The processor 204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. Antenna 216 may be configured to transmit or receive information, in accordance with the various embodiments described herein. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals. The DSP 220 may be configured to generate a data unit for transmission. In some aspects, the data unit may comprise a physical layer data unit (PPDU). In some aspects, the PPDU is referred to as a packet.

The wireless device 202 may further comprise a user interface 222 in some aspects. The user interface 222 may comprise a keypad, a microphone, a speaker, and/or a display. The user interface 222 may include any element or component that conveys information to a user of the wireless device 202 and/or receives input from the user.

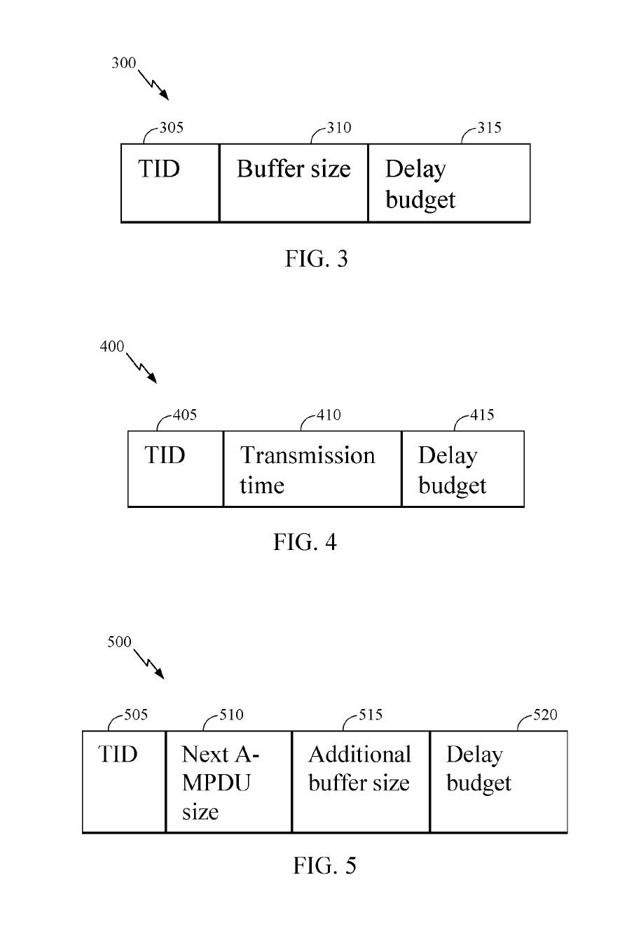

The wireless device 202 may further include a buffer 240 and a buffer information circuit 221. In some aspects, the buffer 240 may be configured to store information before it is transmitted, or once it is received by the wireless device 202. In various embodiments, the buffer 240 may be implemented as a part of one of the other components of the wireless device 202, such as the processor 204, the memory 206, the transmitter 210, the receiver 212, the transceiver 214, DSP 220, or the buffer information circuit 221. The buffer information circuit 221 may contain instructions which allow the wireless device 202 to determine or transmit information about data which is buffered by the wireless device 202 (e.g., by the buffer 240). As illustrated, the buffer information circuit 221 can comprise a determiner 250, which may be configured to determine a buffer size, a transmission time, a next packet size, an additional buffer size (described in further detail below with respect to FIGS. 3-5), or other information related to the buffer 240. Once this buffer information is determined by the determiner 250, the buffer information circuit 221 can be configured to generate a packet for transmitting the buffer information to another device, in accordance with the various embodiments described herein. As illustrated, antenna 216 may be used to transmit this buffer information in accordance with one or more of buffer formats 300, 400, or 500 (described in further detail below). In some aspects, determining or transmitting this buffer information can allow for efficient use of the wireless medium. In some aspects, the transmitted buffer information may inform other devices (e.g., at least one of the STAs 106 or the AP 104) of the amount of data buffered by the wireless device 202 that should be transmitted. In some embodiments, the transmitted buffer information may additionally or alternatively convey other information, such as how urgent buffered data is or how long the wireless device 202 has waited to send the buffered data.

The various components of the wireless device 202 may be coupled together by a bus system 226. The bus system 226 may include a data bus, for example, as well as a power bus, a control signal bus, and a status signal bus in addition to the data bus. Those of skill in the art will appreciate the components of the wireless device 202 may be coupled together or accept or provide inputs to each other using some other mechanism.

Although a number of separate components are illustrated in FIG. 2, those of skill in the art will recognize that one or more of the components may be combined or commonly implemented. For example, the processor 204 may be used to implement not only the functionality described above with respect to the processor 204, but also to implement the functionality described above with respect to the signal detector 218 and/or the DSP 220. Further, each of the components illustrated in FIG. 2 may be implemented using a plurality of separate elements.

### Traffic Information Signaling

In some aspects, it may be possible for multiple devices to make use of the wireless medium simultaneously. For example, OFDMA and MU-MIMO may allow multiple devices, such as multiple STA 106 devices, to transmit to the AP 104 simultaneously. Generally, such a transmission may be triggered by a trigger or poll frame transmitted by the AP 104, such as a “clear to transmit” (CTX) frame or a “clear to send” (CTS) frame. For example, the trigger/poll frame may include an identification of a number of STAs 106, and an indication of the length of time those devices may be allowed to transmit to the AP 104.

Because the AP 104 may wish to send trigger/poll frames to the STAs 106, it may be beneficial to provide a mechanism through which STAs 106 may indicate to the AP 104 that at least one of the STAs 106 has data to transmit to the AP 104. Such indications may allow for efficient scheduling from the AP 104 in determining which devices should be allowed to transmit during a particular transmission opportunity (TXOP). Accordingly, it may be desired for the AP 104 to be able to collect information from the STAs 106 regarding the availability of traffic to be polled (e.g., buffered data).

Whenever an AP 104 sends a CTX, it may be beneficial to know the buffer status of each of the STAs 106 that are associated with the AP 104. Knowing this information may help an AP 104 to determine whether and when to send the CTX, and with what access priority. This information may help the AP 104 select which of the STAs 106 to include in the uplink transmission opportunity (UL TXOP). This information may help the AP 104 determine the correct UL PPDU to receive this information to indicate in the CTX.

There may be a number of ways for a STA 106 to transmit buffer information to the AP 104. These different ways may complement each other when they are used together, or may be used separately from one another. In some aspects, it may be beneficial to limit the number of possible ways for a STA 106 to signal buffer information. If multiple ways of signaling buffer information are provided for a STA 106, it may be beneficial for each of these ways to include the same information format. Such a common format may allow the information to be processed in a similar manner by the AP 104.

There may be at least three general ways in which a STA 106 may inform an AP 104 of buffered data. The STA 106 may include buffer information piggybacked onto other UL (uplink) messages or frames, unsolicited by the AP 104. The STA 106 may also be explicitly polled by the AP 104 for buffer information, for example, through a request for buffer information transmitted from the AP 104 to the STA 106. Finally, the STA 106 may provide an indication of its expected traffic in a manner similar to that of a TSPEC (Traffic Specification). For example, the STA 106 may provide an indication of expected traffic levels once, when the STA 106 first associated with a given AP 104.

Buffer information provided by the STA 106 may contain several different pieces of information. Buffer information may include an indication of the size or the amount of data which a STA 106 has to transmit. This information may be transmitted either in terms of bytes, or in terms of the time it may take to transmit the information. Bytes may be more suitable if the AP 104 is aware of the MCS (Modulation and Coding Scheme) that the STA 106 will use. For example, the AP 104 may have knowledge of the STA's 106 choice in MCS, or the AP 104 itself may choose the MCS. A time duration may be more suitable where the AP 104 does not know the MCS of the STA 106.

In some aspects, if the indication of the amount of buffered data in the buffer information is transmitted in terms of bytes, the number of bytes may reflect the maximum A-MPDU size (in bytes) that the STA 106 would be able to transmit if an UL TXOP was granted. This may be the entire amount of buffered data, or may reflect a maximum size based on BA windowing restrictions, a maximum A-MPDU/A-MSDU size, or based on other restrictions. In various aspects, the buffer size may be indicated as a specific buffer size based upon a multiple of a certain unit, such as a certain number of bytes. In some aspects, the indication of the size of the buffered data may also include an indication of the number of buffered bytes on top of the indicated amount of bytes, such as when multiple TXOPs may be needed to clear the buffer of the STA 106.

The size of the buffered data may also be transmitted using an indication of length of time. For example, this time may be the maximum A-MPDU length (such as in microseconds) that STA 106 would be able to send if an UL TXOP was granted. In some aspects, the time may be determined based at least in part upon one or more of an available buffer size, BA windowing restrictions, the maximum A-MPDU/A-MSDU the STA 106 is configured to use, and the MCS the STA 106 is using. This time measurement may be an amount of time, and may be transmitted as a multiple of a given unit. In some aspects, the STA 106 may also indicate additional transmission time that the STA 106 needs to transmit other data, after the first granted UL TXOP.

In some aspects, the indication of the size of the buffered data may be transmitted in terms of an amount of bytes plus a planned MCS. The combination of both of these pieces of information may inform the AP 104 of, or enable the AP 104 to determine, the time that the STA 106 needs in order to transmit the buffered data, as the planned MCS may indicate the PHY data rate that the STA 106 plans to use (e.g., a rate at which the AP 104 should allow the STA 106 to transmit the data that the STA 106 has buffered for transmission).

Additional information may be included as part of the buffer information. For example, a maximum delay budget of packets currently in the queue may be transmitted by a STA 106. This may indicate how soon the AP 104 should serve the STA 106. A STA 106 may also indicate a maximum delay between a transmission request and a service time from the AP 104. This transmission request may be a separate frame. This delay may also refer to a reference time, such as the TBTT (Target Beacon Transmit Time), in order to ease the processing burden on the AP 104. In some aspects, an indication of a time of the last service provided by the AP 104 to the particular STA 106 may be provided. This indication may help the AP 104 ensure that devices receive access to the wireless medium in a reasonable time frame.

FIG. 3 is an example of a buffer format 300 for buffer information, in accordance with an exemplary embodiment. This buffer format 300 includes a (traffic identification) TID value 305, a buffer size value 310, and a delay budget 315. The buffer size value 310, as discussed above, may be transmitted in bytes or in time. In either case, the value may define a certain number of bytes, or may be defined in other ways. For example, the buffer size value 310 may otherwise indicate a given size of a TXOP that the STA 106 is requesting to be granted. The delay budget 315 may indicate a number of packets that the STA 106 is requesting to transmit. This may allow, for example, an AP 104 to prioritize devices with more packets waiting to be transmitted over devices with a smaller number of packets. This delay budget 315 may also provide an indication of a maximum amount of time that the STA 106 may be able to wait before transmitting the packet. For example, certain types of packets (such as data packets for a voice-over-IP call) may need to be transmitted in a certain amount of time in order to ensure that operation of a given program or device is possible. Thus, the delay budget 315 may indicate a maximum permissible delay in waiting for a TXOP. In some aspect, the delay budget 315 may also indicate a time of the last service provided to the STA 106.

In some aspects, the buffer format 300 may be used to transmit the buffer information within a number of different types of frames, or within different portions of a frame. In some aspects, it may be beneficial to allow a STA 106 to transmit the buffer information, using the buffer format 300, in a number of different types of frames and portions of frames. This may allow a STA 106 to transmit buffer information more often, and may require fewer additional transmissions on the network (as the STA 106 will not need to transmit additional or extra frames just to communicate buffer information).

FIG. 4 is another example of a buffer format 400 for buffer information, in accordance with an exemplary embodiment. Buffer format 400 includes a TID value 405, a transmission time 410, and a delay budget 415. In some aspects, buffer format 400 is similar to buffer format 300, except that here, the buffer information includes a transmission time 410, which indicates the duration (in time) of the requested TXOP. As before, this duration may be indicated by a unit of time (e.g., in microseconds or in another increment), or may be conveyed in some other manner.

FIG. 5 is yet another example of a buffer format 500 for buffer information, in accordance with an exemplary embodiment. Buffer format 500 may be similar to buffer format 300 or buffer format 400 described above. This buffer format 500 includes a TID value 505, a Next A-MPDU Size 510, an Additional Buffer Size 515, and a Delay Budget 520. In some aspects, the Next A-MPDU Size 510 may indicate a size of the next packet (e.g., A-MPDU) which will be transmitted in the next TXOP. This size may be listed in terms of bytes or in another format. The Additional Buffer Size 515 may indicate, for example, how much additional data will be transmitted in future transmissions after the first TXOP.

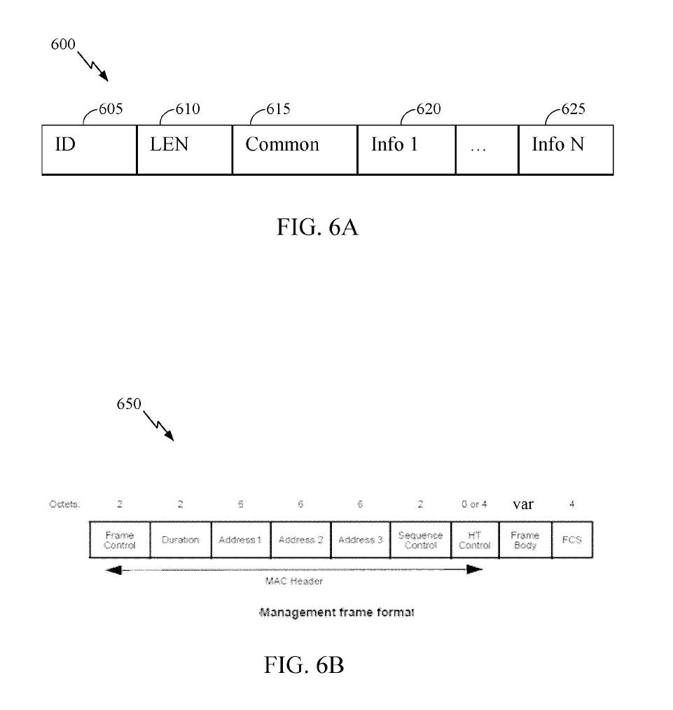

In some aspects, the buffer information, as shown in FIGS. 3-5 may be included within an information element, such as a buffer information element of a larger information element. FIG. 6A is an illustration of an exemplary information element 600 that can be used to convey buffer information, in accordance with an exemplary embodiment. As illustrated, the information element 600 includes an identification element 605, a Length element 610, a number of common elements 615, and buffer information element 620 through to buffer information element 625. In some aspects, the common elements 615 may include information about the format of the information element 600 that allows a device to receive and interpret the message. The common elements 615 may also include the MCS that the STA will use to transmit the buffered data. In some aspects, Buffer Information elements 620 through 625 may be formatted similar to buffer format 300, 400, 500 describe above with respect to FIGS. 3-5. In some aspects, this information element 600 may be added to management frames that STA 106 already sends out. In some aspects, a STA 106 may not send management frames very often, and therefore, other mechanisms may be provided for a STA 106 to transmit its buffer information.

In some aspects, a new type of management frame may be defined, and this information element 600 may be included within that new type of management frame. FIG. 6B is an illustration of a management frame format 650, in accordance with one embodiment. In some aspects, a new action frame may be defined, such as a buffer information frame, which may carry information element 600 and may allow aggregation in AMPDUs. For example, an UL AMPDU may be transmitted which contains both data and buffer information. In some aspects, an UL AMPDU may also be transmitted including an ACK (acknowledgement) and buffer information, or including a block acknowledgement (BA) and buffer information. In one exemplary embodiment, a new frame whose type is management and whose subtype is action may be created to carry the information element 600. This Action subtype may be defined in a version of the IEEE 802.11 standard, such as an 802.11ax standard.

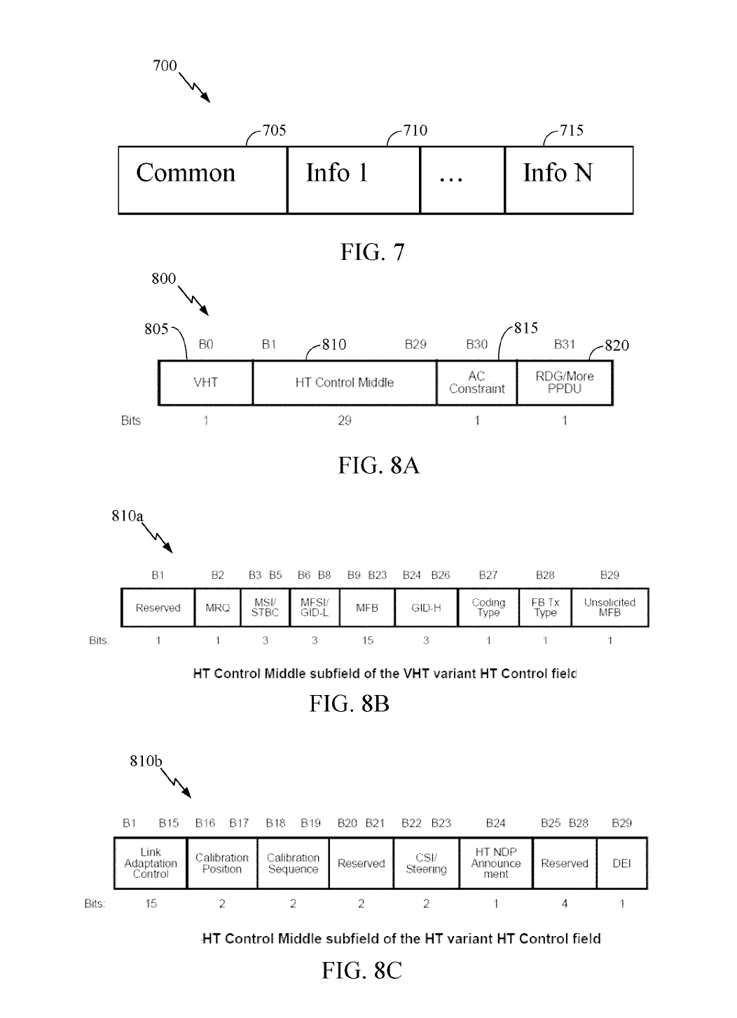

In some aspects, the buffer information may be transmitted by a STA 106 as a field or a subfield. FIG. 7 illustrates buffer information which is transmitted as a subfield of a field 700, in accordance with an exemplary embodiment. For example, the field 700 may contain common subfields 705, based on the type of field which is used. The field may further contain buffer information subfields 710 through 715. These buffer information subfields 710 through 715 may contain the information illustrated in FIGS. 3-5 above. In some aspects, the buffer information may be contained in a single subfield or in multiple subfields. In some aspects, these subfields may be of static length. Generally, these fields or subfields may be attached to any frame.

For example, a MAC header may contain fields which contain buffer information. In some aspects, buffer information could be contained in any MAC header, or may be contained only is certain types of MAC headers. If buffer information is contained in a MAC header, there may be a frame control field which indicates whether or not buffer information is present. It may be useful, for example, to add this information in ACK, BA, and CTS messages. In one or more of these messages, and indication may be provided, indicating the presence of or absence of buffer information fields or subfields. In one aspect, buffer information may override the existing Quality of Service (QOS) control field or the VHT (Very High Throughput) control field.

In some aspects, buffer information may be transmitted as part of a new VHT control field. The design of such a field may be similar the HT (High Throughput) control field design of IEEE 802.11n or 802.11ac. For example, FIG. 8A is an illustration of an HT Control Field 800, in accordance with an exemplary embodiment. An HT Control Field 800 includes a VHT bit subfield 805, an HT Control Middle 810, an AC constraint subfield 815 and an RDG (reverse direction grant) or More PPDU indication 820. In one aspects, the AC constraint subfield 815 is used to indicate if a response to a RDG may contain data frames from any TID. In one aspect, the RDG or More PPDU indication 820 is used to indicate if the packet carrying the frame is followed by another packet. In some aspects, a reserved bit or combination of bits may be “flipped,” or set to a position that previously did not have a meaning, to indicate the presence of buffer information in the field. For example, the VHT bit subfield 805 may be set to 1, and a number of reserved bits in the HT Control Middle 810 subfield may be flipped. By flipping certain bits in the HT Control Middle 810, this may allow the remaining bits to be redefined to, for example, carry buffer information. FIG. 8B is an illustration of the components of the HT Control Middle subfield 810a of a VHT (Very High Throughput) variant, in accordance with an exemplary embodiment. FIG. 8C is an illustration of the components of the HT Control Middle subfield 810b of an HT variant, in accordance with an exemplary embodiment.

In some aspects, a STA 106 may include buffer information as a new control frame. For example, a new control subtype or extension type may be reserved for a frame which carries the fields illustrated in FIGS. 3-5.

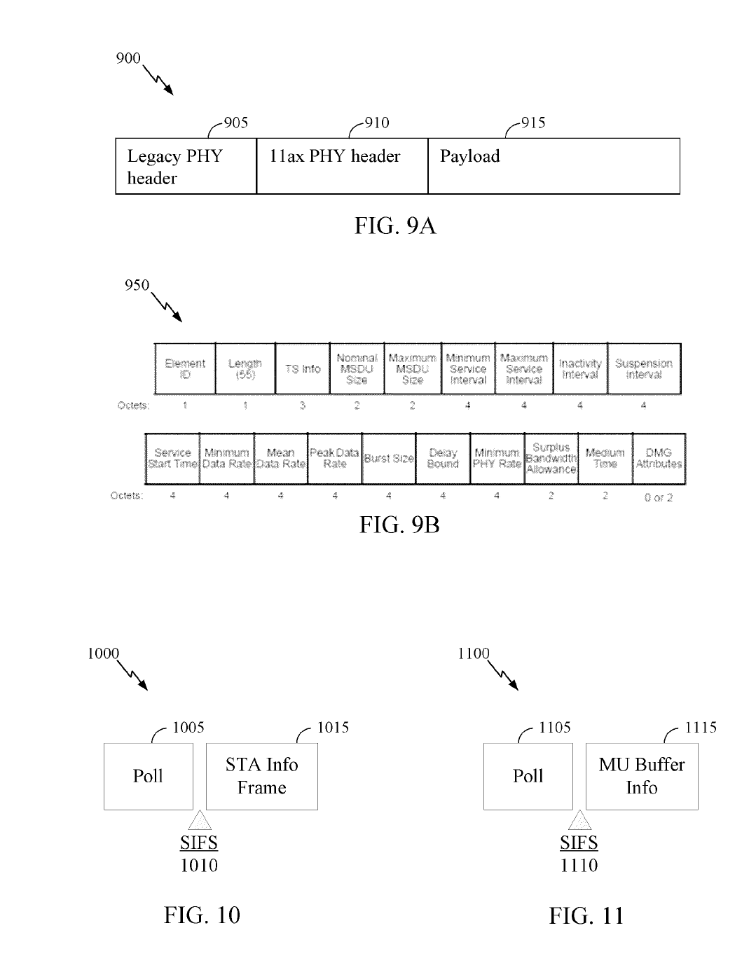

FIG. 9A is an illustration of a general format for an IEEE 802.11ax packet 900, in accordance with an exemplary embodiment. The packet 900 includes a legacy PHY header 905, followed by an 802.11ax PHY header 910, followed by the payload 915 of the packet 900. In some aspects, the legacy PHY header 905 may contain information sufficient to cause devices that are incompatible with IEEE 802.11ax to defer to the 802.11ax packet 900. In some aspects, the 802.11ax PHY header 910 may contain a subfield which carries some or all of the information described above (e.g., buffer information). For example, one or more subfield of the 802.11ax PHY header 910 may contain the information described in FIGS. 3-5. In some aspects, the 802.11ax PHY header 910 may include an identification of the transmitting device and of the intended recipient. Because the 802.11ax PHY header 910 may be used for various purposes, an indication indicating that the bits are used to carry buffer information may also be needed. For example, a one-bit field may be used to indicate the presence or absence of the buffer information. In turn, the buffer information may be formatted in a manner similar to any one of FIGS. 3-5. For example, in some aspects, the buffer information may be carried as an additional SIG field in the 802.11ax PHY header 910. In some aspects, the packet 900 may also be sent without a payload 915. This may be referred to as a null data packet (NDP), and may help a STA 106 transmit buffer information to the AP 104.

In some aspects, certain portions of the buffer information may be transmitted in a TSPEC (traffic specification). FIG. 9B is an illustration of a TSPEC 950, in accordance with an exemplary embodiment. For example, the TSPEC 950 may allow a device to communicate information to the AP 104 at the time of association. Accordingly, a TSPEC 950 may only be sent once (e.g., at the time of association). This information can include the minimum PHY rate, and the minimum/maximum/mean data rate. In some aspects, a specific indication that this information be used to UL multiple-user messages may also be included. In some aspects, the information in the TSPEC 950 may be used to augment the buffer information. For example, the AP 104 may receive buffer information from a STA 106 indicating B bytes of buffered information at time T1. If the AP 104 is aware of the mean arrival rate of the STA 106, such as from the TSPEC 950, this can be used to estimate how much the buffer of the STA 106 has grown to by a later time T2. Accordingly, information from the TSPEC 950 may be used to help an AP 104 determine buffer information of a STA 106.

In some aspects, a STA 106 may not always have a chance to send buffer information along with another transmission, such as when a STA 106 may not send a transmission at a time which would be convenient to also alert the AP 104 of buffered data. In some aspects, accessing the wireless medium merely to send buffer information may not be an efficient use of the wireless medium. Accordingly, it may be beneficial to have a mechanism for an AP 104 to poll buffer information from a STA 106. For efficiency, it may be beneficial to send the information to the AP 104 in a multiple-user mode. The poll interval to be used may vary. For example, the AP 104 may poll the STAs 106 periodically (e.g., on a regular time period), or may poll only when needed, such as when information from certain STAs 106 was stale (e.g., a fixed amount of time has elapsed after receipt of information from a STA 106). In some aspects, the poll may be sent by the AP 104 to a specific STA 106 (single user) or to multiple STAs 106 (to allow for multiple-user buffer information to be transmitted over the wireless medium).

FIG. 10 is an example 1000 of a buffer information poll and a response with a single STA 106, in accordance with an exemplary embodiment. For example, the AP 104 may be configured to transmit a poll 1005 to a single STA 106, in order to determine whether that STA 106 has buffered information for the AP 104. After this, the wireless medium may be quiet for a short interframe space (SIFS) 1010. The STA 106 which has been polled may then respond with a buffer information frame 1015. In one exemplary embodiment, the buffer information frame 1015 may be in a format discussed herein, and may include the buffer information which is described above with respect to one of FIGS. 3-5.

FIG. 11 is an example 1100 of a buffer information poll and a response with multiple STAs 106, in accordance with an exemplary embodiment. In various aspects, the AP 104 may be configured to transmit a poll 1105 to a plurality of STAs 106, in order to determine whether any of the plurality of STAs 106 have buffered information for the AP 104. After this poll 1105, the wireless medium may be quiet for a SIFS 1110. Following this, the plurality of STAs 106 (or a subset of the polled plurality) may simultaneously transmit buffer information 1115 to the AP 104. In one aspect, this simultaneous transmission may be an UL MU-MIMO or an OFMDA transmission, such that the AP 104 may receive buffer information 1115 from a plurality of STAs 106 at the same time. By transmitting this buffer information 1115 in a multiple-user fashion, the wireless medium may be used more efficiently, as more information may be transmitted in a shorter period of time than would be possible using the single user example 1000 of FIG. 10.

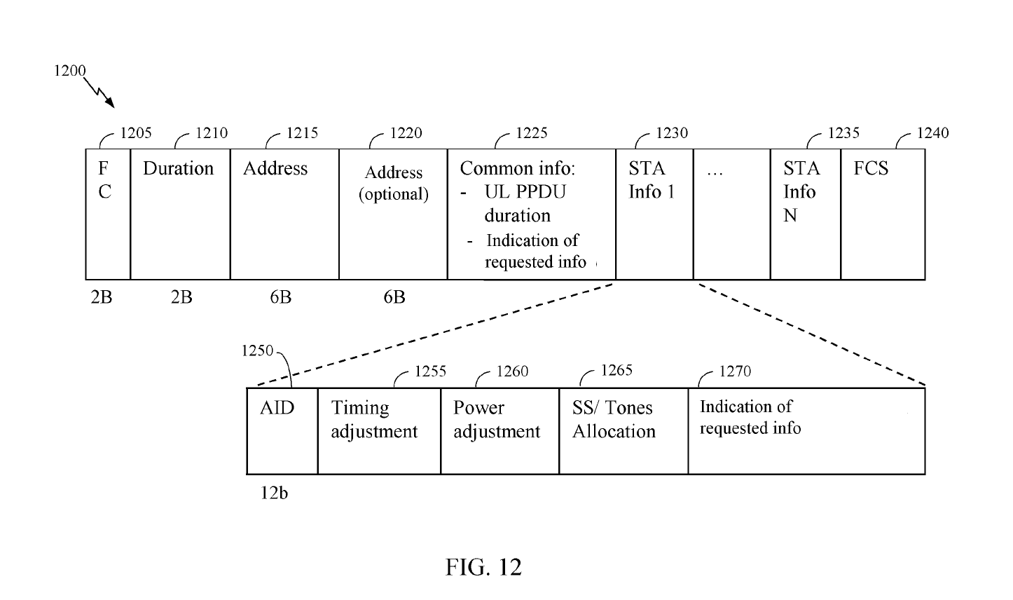

FIG. 12 is an illustration of a possible poll control frame 1200 format, in accordance with an exemplary embodiment. For example, this poll control frame 1200 may be transmitted by an AP 104 in order to request that one or more STAs 106 transmit buffer information. The poll control frame 1200 may include a frame control field 1205 containing control information about the poll control frame 1200 and a duration field 1210 indicating the duration of the poll control frame 1200. The poll control frame 1200 includes an address 1215 and may contain other addresses 1220, which may depend on how many different STAs 106 the poll control frame 1200 is intended for. The poll control frame 1200 may also include common information 1225, which can include an indication of an amount of time that the STA 106 requires to transmit the UL message to the AP 104, such as an UL PPDU duration for the requested UL message or packet (which includes the buffer information), or an indication of the requested information, such as the buffer information. The poll control frame 1200 may include STA Info 1230 through 1235 for each of N STAs. Finally the poll control frame 1200 may include a Frame Check Sequence (FCS) 1240.

Each of the STA Info 1230 through 1235 portions of the packet may include a number of elements. For example, each may include an AID (Association ID) 1250, a timing adjustment 1255, a power adjustment 1260, an allocation of the tones and/or spatial streams 1265, and an indication of the requested information 1270, such as buffer information. In some aspects, a STA 106 may use the STA Info 1230 through 1235 it receives to determine when to send a response, at what power to send a response, and with what tones and spatial streams to send a response. Accordingly, this information may be used to help a STA 106 transmit a response to the AP 104 which is synchronized with responses from other STAs 106. For example, the indication of the requested information 1270 may indicate that the AP 104 is requesting to receive delay statistics or information on buffer size (e.g., in one of either bytes or time duration), or may otherwise indicate what buffer information is requested from the STAs 106.

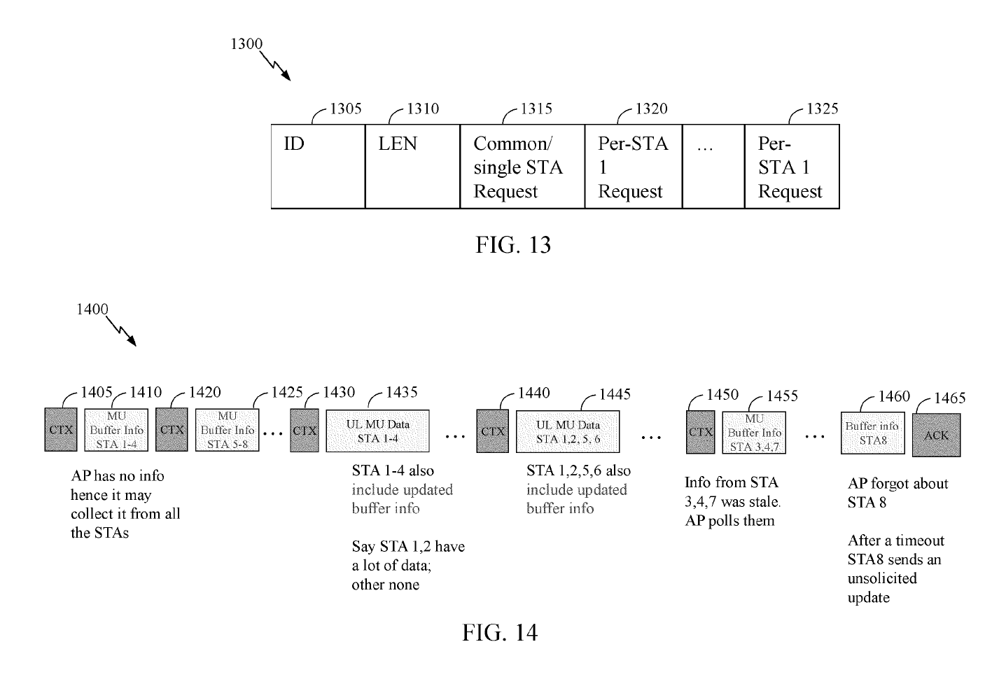

In some aspects, a poll frame from the AP 104 may be a management frame. FIG. 13 illustrates a possible format for a poll frame 1300 that is a management frame, in accordance with an exemplary embodiment. In some aspects the poll frame 1300 includes information element requests 1320 through 1325 requesting information from one or more STAs 106 individually. The poll frame 1300 may also include a common STA request 1315. In the special case where the poll frame 1300 is transmitted to only a single STA 106, the common STA request 1315 may serve as a single STA 106 request element. The poll frame 1300 may also include an identification 1305 and a length 1310. Each STA 106 that receives the poll frame 1300 may respond with a management frame which includes the buffer information of FIGS. 3-5. In some aspects, the responses from the STAs 106 may also be transmitted to the AP 104 using any of the other methods described above (e.g., in addition to or instead of using a management frame).

FIG. 14 illustrates an example of a series 1400 of communications between an AP 104 and a number of STAs 106 (e.g., STAs 106 numbered as 1-8 for illustration) according to some aspects of the present disclosure. At the beginning of the series 1400 of communications, the AP 104 may have no information from any of the STAs 106 in the network, so it may transmit a CTX message 1405 asking for this information. For example, this CTX message 1405 may be similar to the poll control frame 1200 of FIG. 12 or poll frame 1300 of FIG. 13. This message may be transmitted to the four STAs 106 numbered 1-4. These four STAs 106 may then transmit a multiple-user simultaneous response 1410. Next the AP 104 may poll 1420 the STAs 106 numbered 5-8, and those STAs 106 may similarly transmit a multiple-user simultaneous response 1425. Later, the AP 104 may transmit a CTX message 1430 allowing STAs 106 numbered 1-4 to transmit their buffered data, and those STAs 106 may transmit 1435 their buffered data in a multiple-user transmission. Some devices, such as STAs 106 numbered 1 and 2, for example, may have more data to transmit than other devices, such as STAs 106 numbered 3 and 4, for example. Accordingly, the AP 104 may then transmit a CTX message 1440 allowing STAs 106 numbered 1, 2, 5, and 6 to transmit their buffered data, as STAs 106 numbered 1 and 2 may still have buffered data remaining, while STAs 106 numbered 3 and 4 may not have buffered data. Accordingly, STAs 106 numbered 1, 2, 5, and 6 may transmit data using an uplink simultaneous transmission 1445. After a period of time, the buffer information from STAs 106 numbered 3, 4, and 7 may have gone stale, so the AP 104 may poll 1450 those devices for updated buffer information. STAs 106 numbered 3, 4, and 7 may then respond 1455 to the poll together, providing updated buffer information. In some aspects, the AP 104 may have failed to request buffer information from STA 106 number 8, or STA 106 number 8 may have failed to receive a request for buffer information, for various reasons. Accordingly, STA 106 number 8 may determine this, and may transmit 1460 buffer information to the AP 104 in an unsolicited transmission. In some aspects, the STAs 106 may be configured to transmit buffer information after a certain period of time if they have not received a request from the AP 104 during that time. Following STA 106 number 8's transmission 1460, the AP 104 may transmit an ACK 1465, acknowledging proper receipt of this transmission.

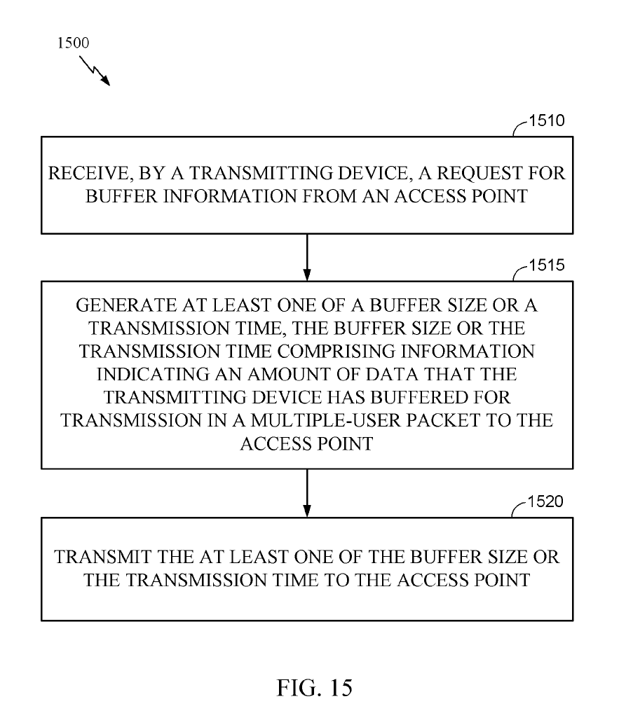

FIG. 15 is a method 1500 of transmitting buffer information from a STA 106 to an AP 104, in accordance with an exemplary embodiment.

At block 1510, a transmitting device, such as one of the STAs 106 or the wireless device 202, receives a request for buffer information from an access point, such as AP 104. At block 1515, the transmitting device generates at least one of a buffer size or a transmission time, the buffer size or the transmission time comprising information indicating an amount of data that the transmitting device has buffered for transmission in a multiple-user packet to the access point. In some aspects, the buffer size may be in bytes. In one aspect, the transmission time can be the number of microseconds that the transmitting device wishes to reserve the wireless medium for, in order to transmit a packet.

At block 1520, the transmitting device transmits the at least one of the buffer size or the transmission time to the access point. In some aspects, the at least one of the buffer size or the transmission time may be transmitted along with a delay budget to the access point. In one aspect the delay budget includes information regarding a delay value of the data that the transmitting device has buffered for transmission. In some aspects, the at least one of the buffer size or the transmission time may be transmitted in a management frame or as a field or subfield, such as in a Very High Throughput (VHT) control field of a PHY header. The delay budget may provide information on acceptable levels of delay for the buffered data, or information on how long the data has been in the buffer, how long since the device has been able to transmit data, or other information relating to the priority of the buffered data.

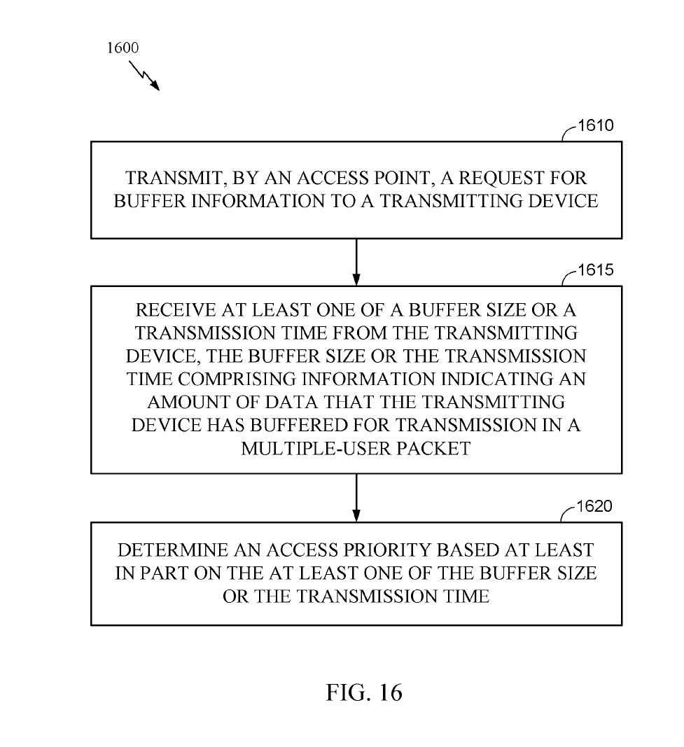

FIG. 16 is a method 1600 of receiving buffer information from a STA 106 by an AP 104, in accordance with an exemplary embodiment. In some aspects, method 1600 may ensure that transmitting devices receive access to the wireless medium within a reasonable time frame, or may otherwise allow for efficient use of the wireless medium.

At block 1610, an access point, such as AP 104, transmits a request for buffer information to a transmitting device, such as one of the STAs 106 or the wireless device 202. In some aspects, transmitting the request for buffer information may be dynamic, and in some aspects transmitting the request for buffer information may be periodic or scheduled. At block 1615, the access point receives at least one of a buffer size or a transmission time from the transmitting device, the buffer size or the transmission time comprising information indicating an amount of data that the transmitting device has buffered for transmission in a multiple-user packet. In some aspects, the buffer size may be in bytes. In one aspect, the transmission time can be the number of microseconds that the transmitting device wishes to reserve the wireless medium for, in order to transmit a packet.

At block 1620, the access point determines an access priority for the transmitting device based at least in part on the buffer size or the transmission time. In one embodiment, this access priority may be used by the access point to generate a polling message. This polling message may be transmitted to the transmitting device to indicate whether or when the transmitting device may transmit the information buffered at the transmitting device. In some aspects, the polling message may indicate how much of the buffered information (e.g., bytes) the transmitting device may transmit. In one aspect, the access point may determine the access priority based at least in part on a MCS of the transmitting device.

### Implementing Systems and Terminology

The word “exemplary” is used herein to mean “serving as an example, instance, or illustration.” Any embodiment described herein as “exemplary” is not necessarily to be construed as preferred or advantageous over other embodiments. Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

It should be understood that any reference to an element herein using a designation such as “first,” “second,” and so forth does not generally limit the quantity or order of those elements. Rather, these designations may be used herein as a convenient wireless device of distinguishing between two or more elements or instances of an element. Thus, a reference to first and second elements does not mean that only two elements may be employed there or that the first element must precede the second element in some manner. Also, unless stated otherwise a set of elements may include one or more elements.

A person/one having ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

A person/one having ordinary skill in the art would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein and in connection with FIGS. 1-7 may be implemented within or performed by an integrated circuit (IC), an access terminal, or an access point. The IC may include a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. The logical blocks, modules, and circuits may include antennas and/or transceivers to communicate with various components within the network or within the device. A general purpose processor may be a microprocessor, but in the alternative, the processor may be any conventional processor, controller, microcontroller, or state machine. A processor may also be implemented as a combination of computing devices, e.g., a combination of a DSP (e.g., the DSP 220) and a microprocessor, a plurality of microprocessors, one or more microprocessors in conjunction with a DSP core, or any other such configuration. The functionality of the modules may be implemented in some other manner as taught herein. The functionality described herein (e.g., with regard to one or more of the accompanying figures) may correspond in some aspects to similarly designated “means for” functionality in the appended claims. For example, in various aspects, the means for receiving may comprise a receiver, such as receiver 212, transceiver 214, some combination thereof, or their functional equivalents described herein. In some aspects, the means for transmitting may comprise a transmitter, such as transmitter 210, transceiver 214, some combination thereof, or their functional equivalents described herein. In various embodiments, the means for receiving or means for transmitting may further comprise additional components, such as processor 204, memory 206, buffer information circuit 221, determiner 250, some combination thereof, or their functional equivalents described herein. In some aspects, the means for generating may comprise a processor or some other circuit, such as processor 204, memory 206, buffer information circuit 221, determiner 250, some combination thereof, or their functional equivalents described herein.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method of communicating within a wireless communication network, the method comprising:
receiving, by a transmitting device, a request for buffer information from an access point;
generating at least one of a buffer size or a transmission time, the buffer size or the transmission time comprising information indicating an amount of data that the transmitting device has buffered for transmission in a multiple-user packet to the access point; and
transmitting the at least one of the buffer size or the transmission time to the access point.

2. The method of claim 1, wherein the buffer size comprises an indication of a maximum of a number of bytes of data contained in a buffer of the transmitting device and an indication of a number of bytes that may be transmitted in an uplink message to the access point.

3. The method of claim 1, wherein the transmission time comprises an indication of an amount of time that the transmitting device requires to transmit an uplink message to the access point.

4. The method of claim 1, further comprising transmitting a delay budget to the access point, the delay budget including information regarding a delay value of the data that the transmitting device has buffered for transmission.

5. The method of claim 4, wherein the delay budget indicates a rate at which the access point should allow the transmitting device to transmit the data that the transmitting device has buffered for transmission.

6. The method of claim 1, wherein the buffer size further comprises an indication of a size of a next packet from the transmitting device and an indication of how much additional data the transmitting device has buffered other than the next packet.

7. The method of claim 1, wherein the at least one of the buffer size or the transmission time are transmitted as part of a management frame.

8. The method of claim 1, wherein the at least one of the buffer size or the transmission time is transmitted in a VHT control field of a physical layer header.

9. A transmitting device for communicating within a wireless communication network, the transmitting device comprising:
a receiver configured to receive a request for buffer information from an access point;
a processor configured to generate at least one of a buffer size or a transmission time, the buffer size or the transmission time comprising information indicating an amount of data that the transmitting device has buffered for transmission in a multiple-user packet to the access point; and
a transmitter configured to transmit the at least one of the buffer size or the transmission time to the access point.

10. The transmitting device of claim 9, wherein the buffer size comprises an indication of a maximum of a number of bytes of data contained in a buffer of the transmitting device and an indication of a number of bytes that may be transmitted in an uplink message to the access point.

11. The transmitting device of claim 9, wherein the transmission time comprises an indication of an amount of time that the transmitting device requires to transmit an uplink message to the access point.

12. The transmitting device of claim 9, wherein the transmitter is further configured to transmit a delay budget to the access point, the delay budget including information regarding a delay value of the data that the transmitting device has buffered for transmission.

13. The transmitting device of claim 12, wherein the delay budget indicates a rate at which the access point should allow the transmitting device to transmit the data that the transmitting device has buffered for transmission.

14. The transmitting device of claim 9, wherein the buffer size further comprises an indication of a size of a next packet from the transmitting device and an indication of how much additional data the transmitting device has buffered other than the next packet.

15. The transmitting device of claim 9, wherein the transmitter is further configured to transmit the at least one of the buffer size or the transmission time as part of a management frame.

16. The transmitting device of claim 9, the transmitter is further configured to transmit the at least one of the buffer size or the transmission time in a VHT control field of a physical layer header.

17. A transmitting device for communicating within a wireless communication network, the transmitting device comprising:
means for receiving a request for buffer information from an access point;
means for generating at least one of a buffer size or a transmission time, the buffer size or the transmission time comprising information indicating an amount of data that the transmitting device has buffered for transmission in a multiple-user packet to the access point; and
first means for transmitting the at least one of the buffer size or the transmission time to the access point.

18. The transmitting device of claim 17, wherein the buffer size comprises an indication of a maximum of a number of bytes of data contained in a buffer of the transmitting device and an indication of a number of bytes that may be transmitted in an uplink message to the access point.

19. The transmitting device of claim 17, wherein the transmission time comprises an indication of an amount of time that the transmitting device requires to transmit an uplink message to the access point.

20. The transmitting device of claim 17, further comprising second means for transmitting a delay budget to the access point, the delay budget including information regarding a delay value of the data that the transmitting device has buffered for transmission.

21. The transmitting device of claim 20, wherein the delay budget indicates a rate at which the access point should allow the transmitting device to transmit the data that the transmitting device has buffered for transmission.

22. The transmitting device of claim 17, wherein the buffer size further comprises an indication of a size of a next packet from the transmitting device and an indication of how much additional data the transmitting device has buffered other than the next packet.

23. The transmitting device of claim 17, further comprising third means for transmitting the at least one of the buffer size or the transmission time in a VHT control field of a physical layer header.

24. A non-transitory computer readable medium comprising instructions that, when executed, perform a method of communicating within a wireless communication network, the method comprising:
receiving a request for buffer information from an access point;
generating at least one of a buffer size or a transmission time, the buffer size or the transmission time comprising information indicating an amount of data that a transmitting device has buffered for transmission in a multiple-user packet to the access point; and
transmitting the at least one of the buffer size or the transmission time to the access point.

25. The non-transitory computer readable medium of claim 24, wherein the buffer size comprises an indication of a maximum of a number of bytes of data contained in a buffer of the transmitting device and an indication of a number of bytes that may be transmitted in an uplink message to the access point.

26. The non-transitory computer readable medium of claim 24, wherein the transmission time comprises an indication of an amount of time that the transmitting device requires to transmit an uplink message to the access point.

27. The non-transitory computer readable medium of claim 24, wherein the method further comprises transmitting a delay budget to the access point, the delay budget including information regarding a delay value of the data that the transmitting device has buffered for transmission.

28. The non-transitory computer readable medium of claim 27, wherein the delay budget indicates a rate at which the access point should allow the transmitting device to transmit the data that the transmitting device has buffered for transmission.

29. The non-transitory computer readable medium of claim 24, wherein the buffer size further comprises an indication of a size of a next packet from the transmitting device and an indication of how much additional data the transmitting device has buffered other than the next packet.

30. The non-transitory computer readable medium of claim 24, wherein the at least one of the buffer size or the transmission time is transmitted in a VHT control field of a physical layer header.
